(19) United States
(12) Patent Application Publication
(10) Pub. No.: US 2008/0206019 A1
(43) Pub. Date: Aug. 28, 2008

(54) Document Cover Assembly Configured For Volume Production

(75) Inventors: David Laufer, Atlanta, GA (US); Charlesworth Hunter Tison, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: GoLux, L.L.C.

(21) Appl. No.: 11/679,252

(22) Filed: Feb. 27, 2007

(51) Int. Cl. B42B 5/06

(52) U.S. Cl. 412/33; 29/525.09

(57) ABSTRACT

The present invention comprises a document binder assembly which may be printed commonly available office equipment, which results in a document binder assembly with exponentially wider distribution, use and much lower cost to the user when compared to the prior art. A slide and spacer in the document binder assembly operate to attach a cover to a bound document. Said cover may be received by a standard printer, wherein a user may print text, logos, graphics, or other desired material onto the cover. Optionally, an adhesive strip may be mounted to the spine of the document to reinforce the strength of the document binder assembly. The result is a document binder assembly useful for making short run full dress documents may be printed on commonly available office equipment, singly or in quantity, and offering highly desirable combination of low cost, professional appearance, and ease of decoration on all surfaces.

### FIELD OF THE INVENTION

The present invention relates to the field of document binder assemblies, and more specifically, relates to a document binder assembly, and method for manufacturing same, that is configured for volume production and allows users to create document binder assemblies quickly, inexpensively, and in low quantities.

### BACKGROUND OF THE INVENTION

Currently, businesses and individuals alike have a need to present documents in an aesthetically pleasing manner. In the world of business, this need may arise when presenting marketing materials to a potential client, submitting a business proposal, or dispersing reports at a large meeting. Individuals also have a need for presenting bound documents in an aesthetically pleasing manner, including students who may prepare book reports and term papers which, if bound, have a pleasing appearance as well as enjoying the benefits of having the pages securely bound together versus a less secure staple or paperclip.

Frequently, business and individuals turn to binding their documents via a coil binding technique. This technique involves a round coil binding which pierces each page via a hole placed in the left side periphery of the page. The coil binding is typically applied to the pages via a designated device, which is usually available at most document service retail establishments. This coil binding technique is a popular method for presenting documents because of the effectiveness of the coil in keeping the pages bound together, as well as the low cost for such a technique. Coil binding is also ubiquitous because of the ease of use such binding offers for users. For example, coil binding is a quick method of binding documents. A user may print, bind and ship a document within a few minutes. Coil binding is reversible, as pages may be replaced or substituted after the document is bound, if needed. Further, the coil binding technique comparatively low cost and lies flat when opened. These factors contribute to the coil binding technique favoring low production volume projects.

However, the coil binding technique comprises several disadvantages. One such disadvantage includes difficulty in identifying the document when stacked or placed on a bookshelf. Because the coil binding does not comprise sufficient area to place any text, graphic, or logo, the document is usually identified by the front cover, which is not visible when stacked or stored on a bookshelf. Another alternative is taping an identifier, such as a label with printed material, on the coil binding. This alternative is undesirable for the taped identifier usually detaches over time, and detracts from the overall appearance of the document.

As a result, various mechanisms for presenting documents have arisen in the prior art. These mechanisms include document binder assemblies which involve a cover for a coil bound document. An example of such a document binder assembly includes U.S. Patent Application 20050254885 to David Laufer, filed on May 13, 2004 (hereinafter referred to as “the '885 Application”). The assembly in the '885 Application provides a breakthrough in the document binder assembly market by providing a document binder assembly configured to serve the needs of mass market desktop binding systems.

However, the assembly in the '885 Application requires a non-standard size of paper, as the assembly in the '885 Application is configured for customized printing in a commercial printing environment. For example, the document binder assembly in the '885 Application requires 14×20″ sheet, which is a standard-sized commercial printing paper. In order to effectuate the printing of the '885 Application, a user would likely utilize the services of a special manufacturer offering services in accordance with the '885 Application.

Thus, there is a need in the prior art for a document binder assembly which is configured for the mass market, that allows users to produce desktop bound documents quickly, inexpensively, and in low quantities.

### SUMMARY OF THE INVENTION

The present invention comprises a document binder assembly which overcomes the aforementioned disadvantages in the prior art by providing a document binder assembly which, by means of a different configuration of components, makes the covers imprintable on commonly available office equipment, allows exponentially wider distribution, use and much lower cost to the user. In one embodiment, the document binder assembly in accordance with the present invention covers a bound document, and comprises a slide having an insert portion at a first side thereof and an engagement portion at a second opposite side thereof; a cover including a first wrap portion at a first side thereof, a second wrap portion at a second opposite side thereof, the second wrap portion receiving the insert portion of the slide, and an intermediate portion between the first wrap portion and the second wrap portion. A spacer is affixed to said cover of the document binder assembly and received by the slide by a notch in the slide. The resulting document binder assembly is an improvement over the prior art for the cover for said document binder assembly may be printed on most standard printers, which aids volume production. Furthermore, said spacer as provided by the present invention provides a unique and effective way to secure the cover to the document binder assembly.

Additional objectives, features and advantages will be apparent in the written description which follows, while referring to the drawings.

### BRIEF DESCRIPTION OF DRAWINGS

Reference will now be made to the accompanying drawings, which are not necessarily drawn to scale, and wherein:

FIGS. 1A and 1B illustrate the document binder assembly in accordance with an embodiment of the present invention.

FIGS. 2A-2C illustrate a bound document as utilized in an embodiment of the present invention.

FIG. 3 is a system diagram illustrating the system components of the document binder assembly in accordance with an embodiment of the present invention.

FIG. 4 illustrates the slide as utilized in an embodiment of the present invention.

FIG. 5 is a system diagram illustrating the slide in accordance with an embodiment of the present invention broken into pre-cut components.

FIG. 6 is a system diagram illustrating the application of adhesive on the cover 110 in accordance with an embodiment of the present invention.

FIG. 7 is a system diagram illustrating the placement of the spacer in accordance with an embodiment of the present invention.

FIG. 8 is an illustration of the back interior of document binder assembly 1 in a completed state.

FIG. 9 is an illustration of an embodiment using a snap for a spacer.

FIGS. 10A, 10B & 10C illustrate an embodiment utilizing tabs and slots to perform the function of the spacer.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

For the purpose of describing the present invention in detail, certain terms used hereinafter are defined as follows:

“Binding member” includes, but is not limited to, the following: brads, staples, saddle stitching, perfect binding, plastic coil, metal wire coil, plastic comb, plastic post, plastic disk, wire, ring binder, Smythe sewn, kettle stitched process by hand, adhesive, or combinations of the above elements.

“Printed material” includes but is not limited to alphanumeric characters, numerals, trademarks, any graphic and textual marks.

“Bound document” includes, but is not limited to, reports, analyses, proposals, marketing materials, brochures, manuals, guides, prospectus, booklets, and other such items.

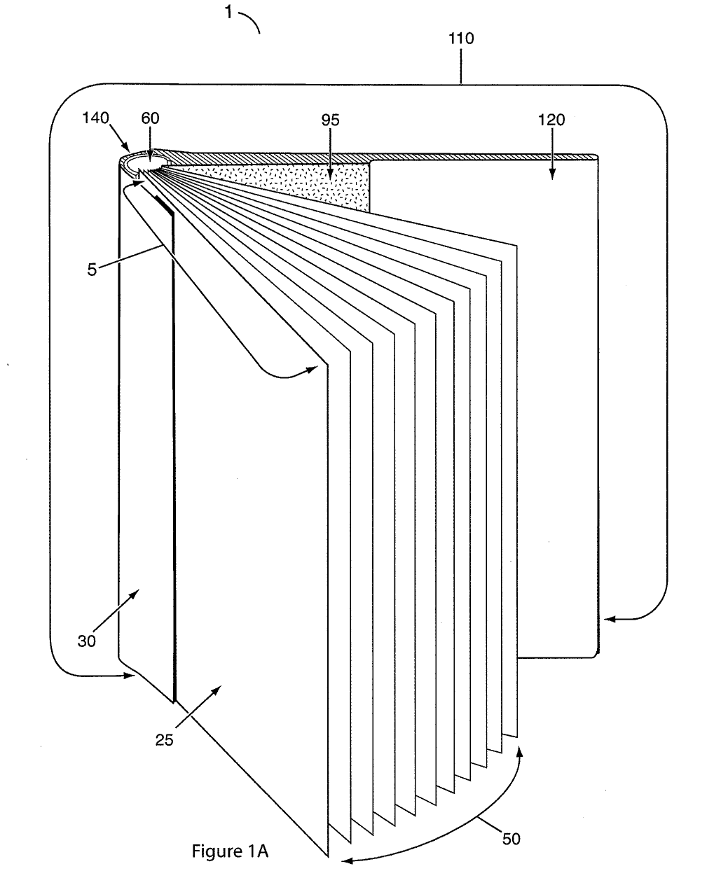

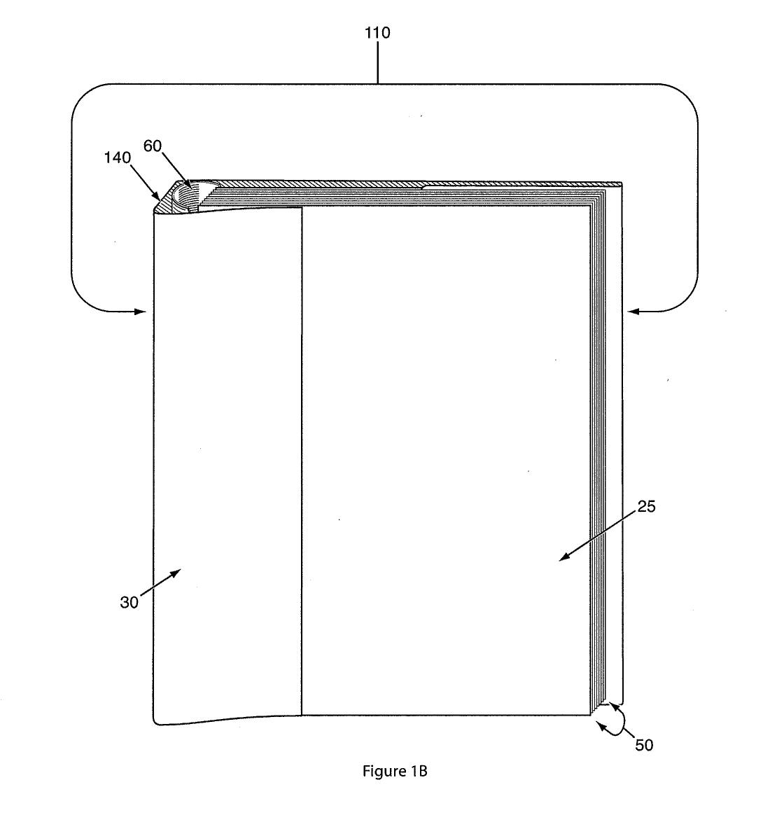

FIGS. 1A and 1B illustrate the document binder assembly in accordance with an embodiment of the present invention. Referring to FIG. 1A, document binder assembly 1 comprises a bound document 5 comprising a multiplicity of sheets 50 bound by binding member 60 and having a front cover 25. The multiplicity of sheets may be of any size, including but not limited to, letter size (8.5″×11″) or A4 size (as defined by ISO 216, which comprises 210 mm×297 mm).

Cover 110 comprises a first wrap portion 30 which is attached to front cover 25 of bound document 5. Second wrap portion 120 encloses a slide 95, which is attached to binding member 60 after the multiplicity of sheets 50 of bound document 5. Text, graphics, or other printed material may be printed on cover 110 by a standard printer or specialized commercial use printer. The resulting document binder assembly 1 is an attractive, innovative approach to presenting a bound document 5 which allows printed material to be printed on cover 110.

FIG. 1B illustrates the document binder assembly 1 from a front view when in a closed position. Binding member 60, which binds the multiplicity of pages 50, is enclosed within document binder assembly by cover 110. Thus, text or graphics may be printed on cover 110 on the other side of binding member 60 on spine portion 140.

First wrap portion 30 adheres directly to front cover 25. An adhesive strip may be used to adhere first wrap portion 30 to front cover 25, but those skilled in the art will recognize that other mechanisms may be utilized within the spirit of the present invention. This adhesive strip may be applied by the user, or applied during the manufacturing process of cover 110.

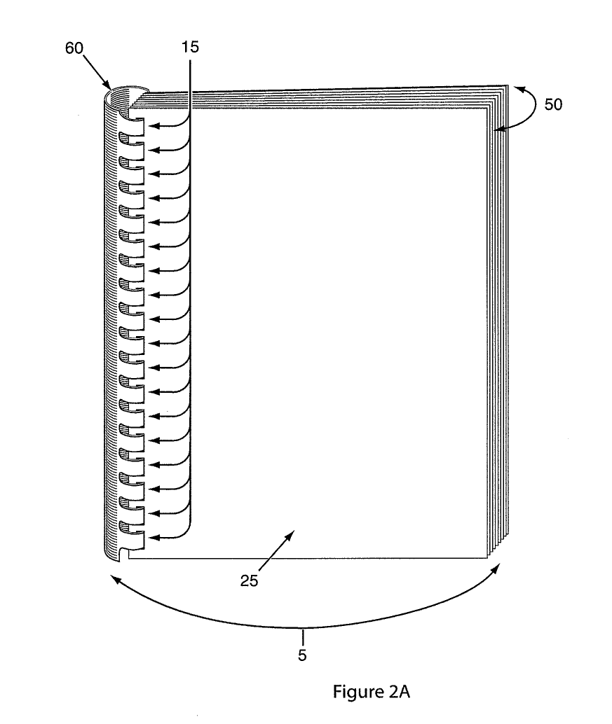

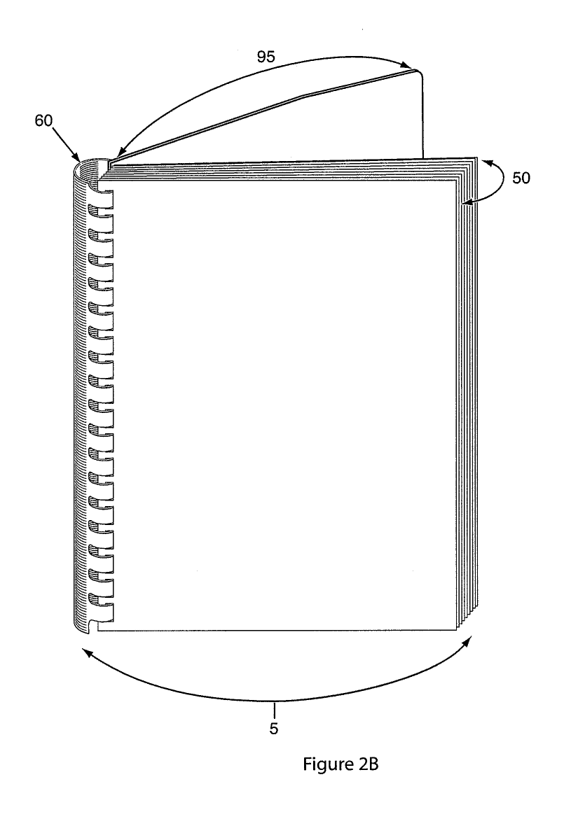

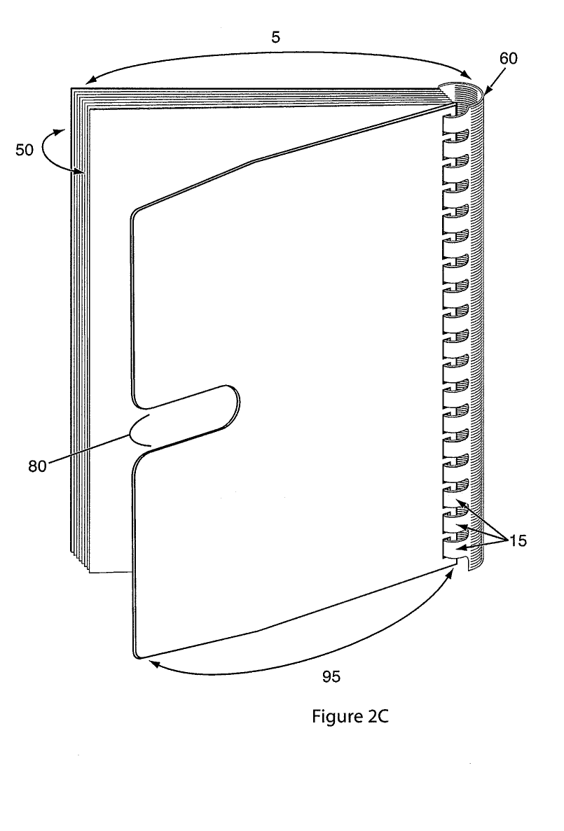

FIGS. 2A-2C illustrate a bound document as utilized in an embodiment of the present invention. Referring to FIG. 2A, the bound document 5 comprises a front cover 25. The front cover is linked to bound document 5 via binding member 60. Front cover 25 may be of any material capable of being bound to the multiplicity of pages 50 by binding member 60, including but not limited to, paper or plastic. Binding member 60 may be any binding mechanism capable of binding a multiplicity of pages, including but not limited to a coil binding, a spiral binding, an adhesive binding, a brad binding, or one or more staples.

Bound document also comprises a multiplicity of pages 50, which are preferably made of paper and bound together by binding member 60. The pages 50 may comprise perforations 15 on the left periphery for receiving the binding member 60. The size of the perforations 15 will vary depending on the size needed to receive binding member 60, as binding members vary in size depending on the amount of pages in the bound document.

FIG. 2B is a front view of a bound document 5 with slide attached in accordance with an embodiment of the present invention. Slide 95 is attached after the last page of the multiplicity of pages 50 to the bound document 5 via binding member 60. The attachment of slide 95 to bound document 5 will be described in greater detail in the following description of FIG. 2C.

FIG. 2C is a back view of a document binder assembly with slide 95 attached in accordance with an embodiment of the present invention. Bound document 5 comprises slide 95, which is attached to the bound document 5 via the binding member 60. Slide 95 comprises perforations 100 which receive binding member 60. Binding member 60 also holds a multiplicity of pages 50 behind slide 95. Slide 95 defines a notch 80, which is an indention cut into slide 95. The size of notch 80 may vary depending on the size of a spacer which is received by slide 95, but cannot be of such variance in size from the spacer as to allow for possible misalignment of the document binder assembly 1.

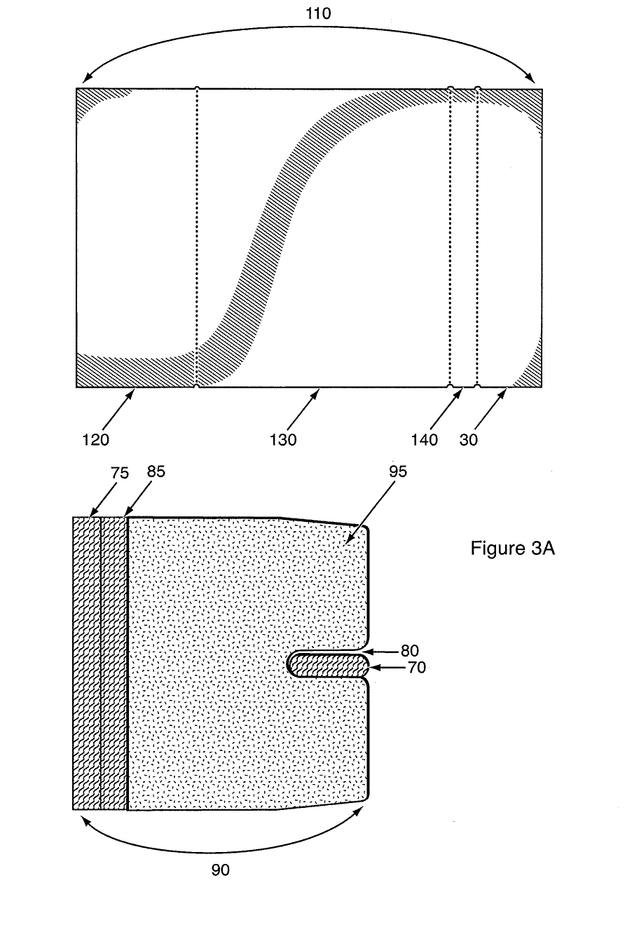

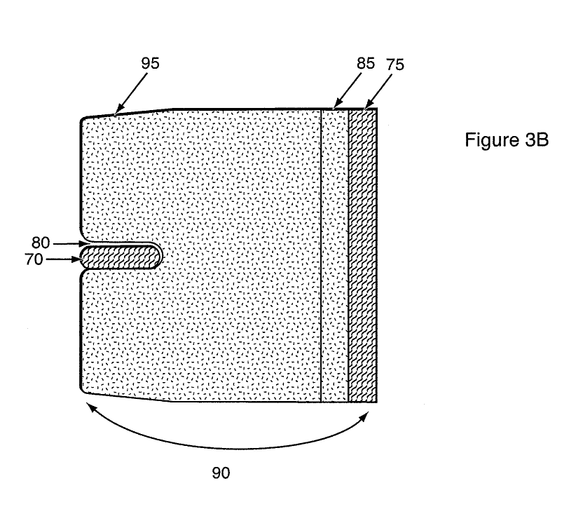

FIG. 3 is a system diagram illustrating the system components of the document binder assembly in accordance with an embodiment of the present invention. Cover 110 comprises several areas, including first wrap portion 30, spine portion 140, intermediate portion 130, and second wrap portion 120. These areas may be defined via a variety of methods, including but not limited to, folded creases in cover 110, or printed lines on cover 110 scoring each area. Preferably, these areas are defined by a printed dotted line on cover 1 10 to indicate a machine score to facilitate folding of the cover 1 10 into the several areas listed above.

Information such as graphics, text, or other branding material may be printed and displayed on cover 1 10. To print information on the cover 1 10, a user may use a program on a personal computer. Alternatively, a user may use a dedicated device to print the information on the cover 110. If a personal computer is utilized, the information may be printed on cover 110 via a command from the program. Such program may comprise, but is not limited to, an MS Office (TM) application or Adobe Creative Suite (TM) program.

Slide portion 90 comprises first slide portion 75, second slide portion 85, and the slide 95. First slide portion 75 is preferably coated with adhesive on both sides to enable the slide 95 to be connected to the cover 110. However, other adhering mechanisms other than adhesive may be utilized within the scope of the present invention. Also, the user may apply adhesive to first slide portion 75, instead of first slide portion 75 receiving the adhesive on both sides during the manufacturing process.

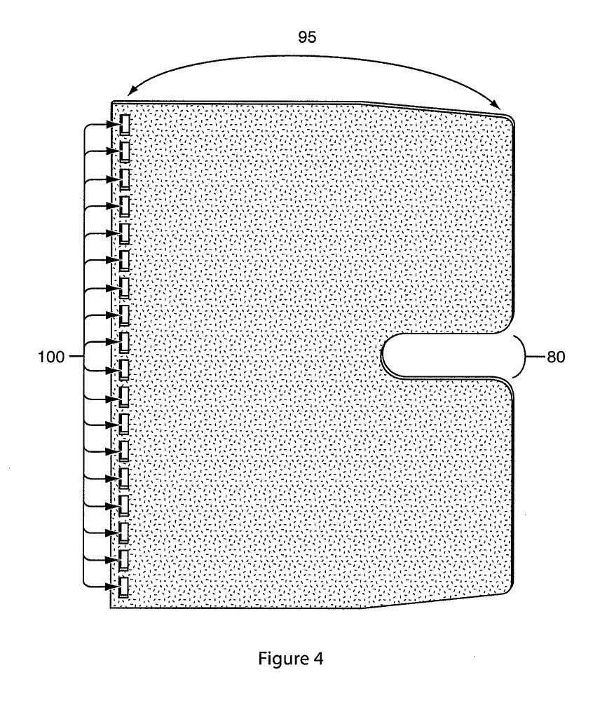

FIG. 4 illustrates the slide as utilized in an embodiment of the present invention. Slide 95 is preferably made of paper or a paper product, but may be made of any other material (e.g., plastic) capable of being bound by binding member 60. The first outer edge of slide 95 defines notch 80 for receiving spacer 70. The first outer edge of slide 95 comprises the insert portion of slide 95, for the insert portion of slide 95 is configured to slide in between cover 110 and second wrap portion 120.

Perforations 100 are located on the second outer edge of slide 95 as to enable slide 95 to be bound by binding member 60. These perforations 100 comprise the engagement portion of slide 95, for the perforations 100 engage the slide 95 with the binding member 60. The size of the perforations 100 will vary depending on the size needed to receive the particular binding member 60, as binding members exist in various sizes in the industry.

However, if binding member 60 does not require perforations 100 to bind a multiplicity of pages together, slide 95 may not comprise perforations 100 along the second outer edge. In this circumstance, the engagement portion will be the edge of the slide 95 which engages the binding member 60.

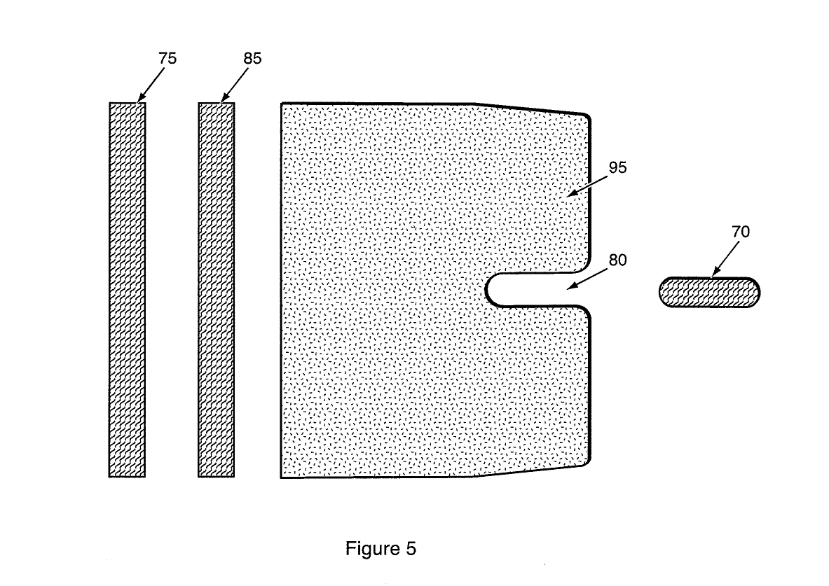

FIG. 5 is a system diagram illustrating the slide portion 90 in accordance with an embodiment of the present invention broken into pre-cut components. Slide portion 90 is broken apart by the user into first slide portion 75, second slide portion 85, slide 95, and spacer 70. The first slide portion 75 and second slide portion 85 are preferably covered with an adhesive material. Alternatively, a user may apply adhesive to first slide portion 75 and second slide portion 85 as part of the assembly process of document binder assembly 1.

Slide portion 95 is preferably manufactured to comprise spacer 70 as an attachment to slide portion 90, where in the spacer 70 is configured to be removed by a user as part of the assembly process of document binder assembly 1. The removal of spacer 70 from slide portion 90 creates a cavity in slide 95. Thus, after the removal of spacer 70, the perimeter of slide 95 defines a notch 80 for receiving spacer 70. Spacer 70 may be perforated in such a manner as to provide for easy removal from slide 90. However, spacer 70 may also be manufactured separately, or removed before providing the document binder assembly 1 to an end user

The perimeter of slide 95 defining the notch remaining after removal of spacer 70 comprises the insert portion of slide 95. Thus after assembly, spacer 70 is adhered to intermediate portion 130, and performs the crucial task of holding slide 95 in place longitudinally, while allowing it to slide latitudinally. This feature allows the document binder assembly 1 to close smoothly in operation and lay flat when open.

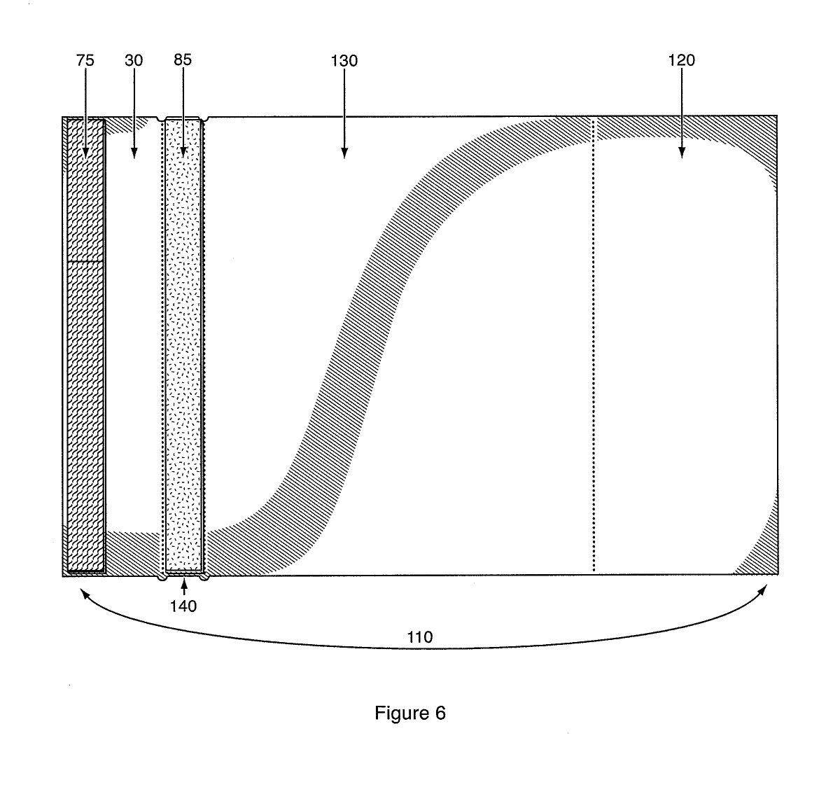

FIG. 6 is a system diagram illustrating the application of adhesive on the cover 110 in accordance with an embodiment of the present invention. Cover 110 comprises several portions: first wrap portion 30, second wrap portion 120, intermediate portion 130, and spine portion 140. The first slide portion 75 and second slide portion 85 are manufactured to be placed on the outer edge of first wrap portion 30 and spine portion 140. For purposes of illustration, first slide portion 75 is applied to first wrap portion 30, and second slide portion 85 is applied to spine portion 140. However, the first slide portion 75 may be applied to spine portion 140, and second slide portion 85 may be applied to first wrap portion 30 if first slide portion 75 and second slide portion 85 are of equal dimensions.

In FIG. 6, cover 110 comprises an optional reinforcement of the spine portion 140, which is created when second slide portion 85 is placed over spine portion 140 to provide additional strength and support along the spine portion 140 of the document binder assembly 1. The additional strength provided by the optional spine reinforcement prevents crushing or damage to the spine area. The adhesive may be placed on the interior side of spine portion 140, which is the side of spine portion 140 which faces the bound document 5 when the document binder assembly 1 is fully assembled. Any damage to the spine area negatively affects the life of the document binder assembly 1 and impacts the legibility of any graphics, text, or other printed material placed on the spine portion 140. This damage is increasingly likely to occur if the binding member 60 is of smaller size than the width of the spine portion 140.

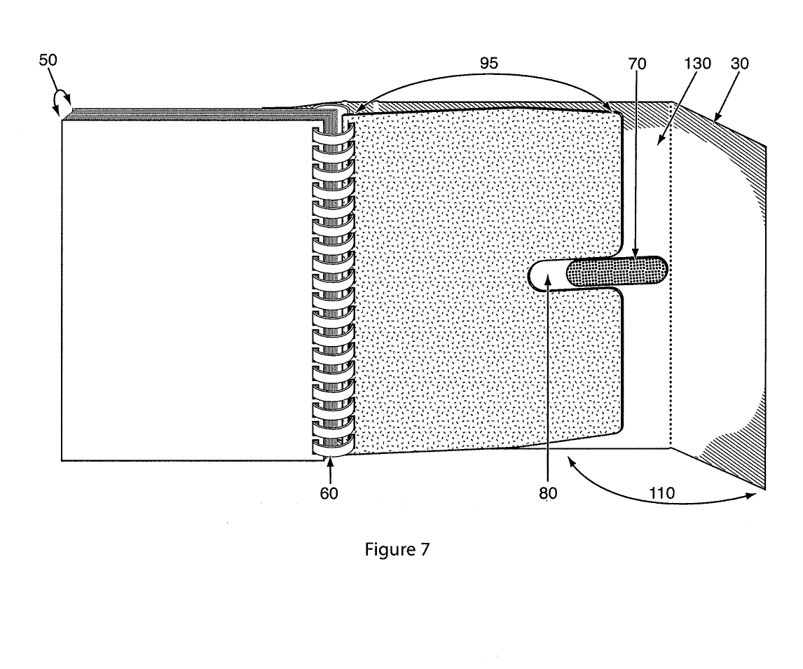

FIG. 7 is a system diagram illustrating the placement of the spacer in accordance with an embodiment of the present invention. Spacer 70 is preferably an object composed of paper, paper product, or plastic, covered on both sides with an adhesive material, and is configured to be placed on cover 110 in such a position that the spacer 70 is received by the notch 80 defined by slide 95. One side of spacer 70 is attached to the intermediate portion 130 of cover 110. The other side of spacer 70 which is not attached to intermediate portion 130 is configured to be attached to second wrap portion 120.

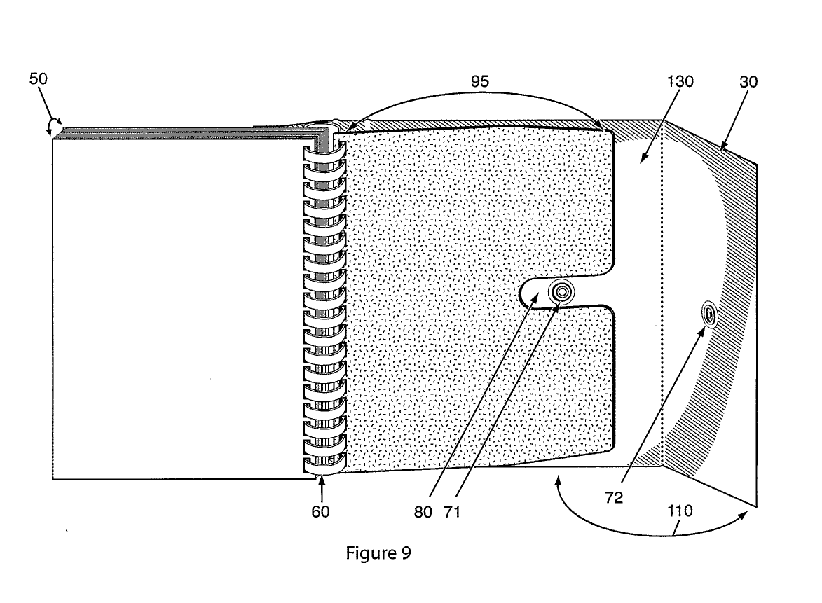

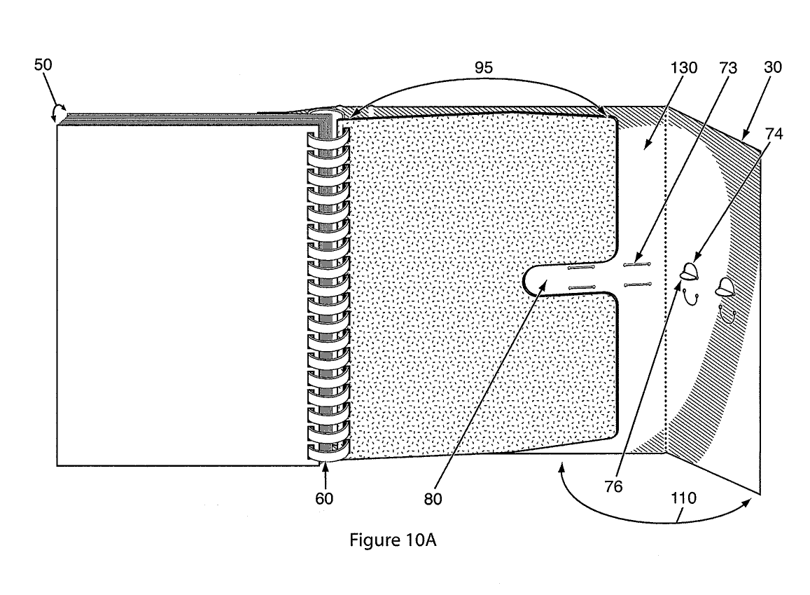

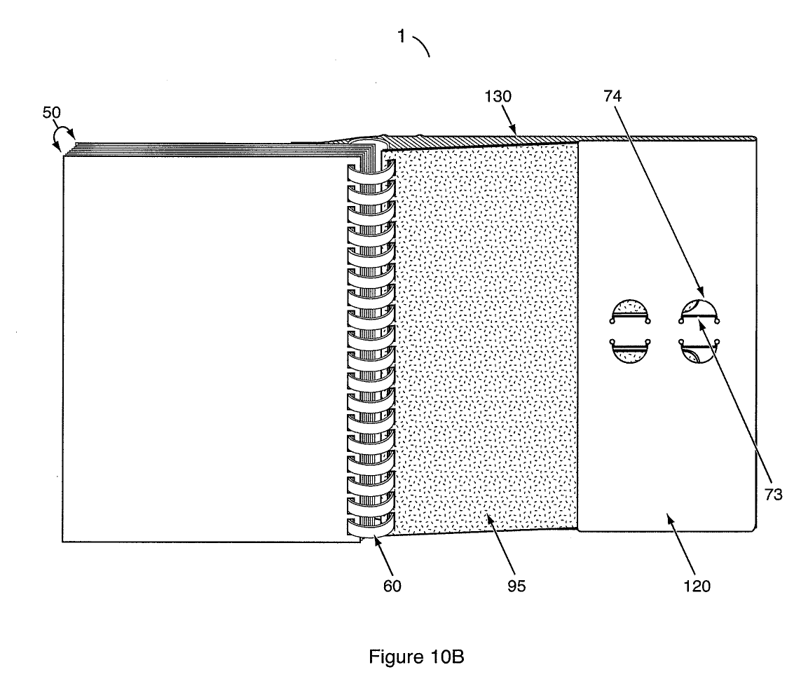

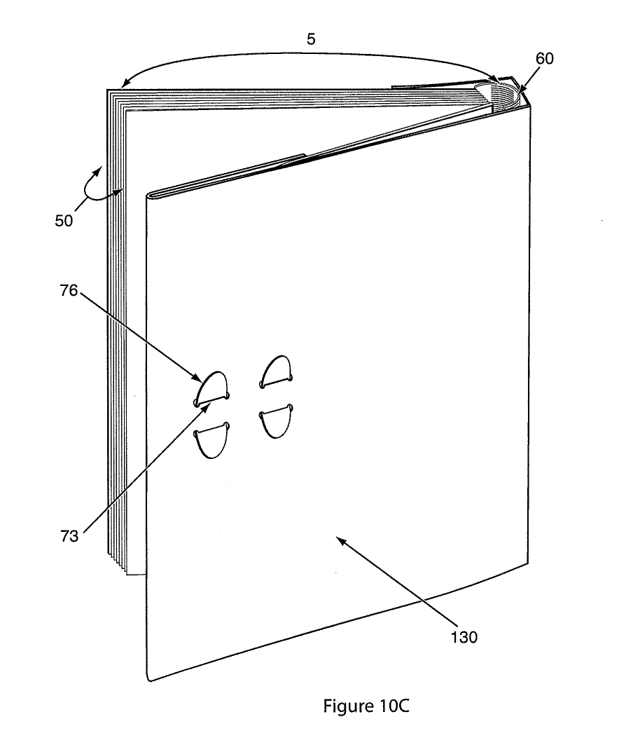

Spacer 70 is described as comprising an object with adhesive on both sides. However, spacer 70 may comprise any object or mechanism for creating a bound area as to receive slide 95 via the notch 80 defined by the first outer edge of slide 95. For example, spacer 70 may comprise, but is not limited to, a Velcro (TM) fastener, one or more snaps, as illustrated in FIG. 9, or interlocking tabs, as illustrated in FIGS. 10A, 10B & 10C. Spacer 70 may also include just the adhesive used to bind intermediate portion 130 to first wrap portion 30, forming an adhesive area.

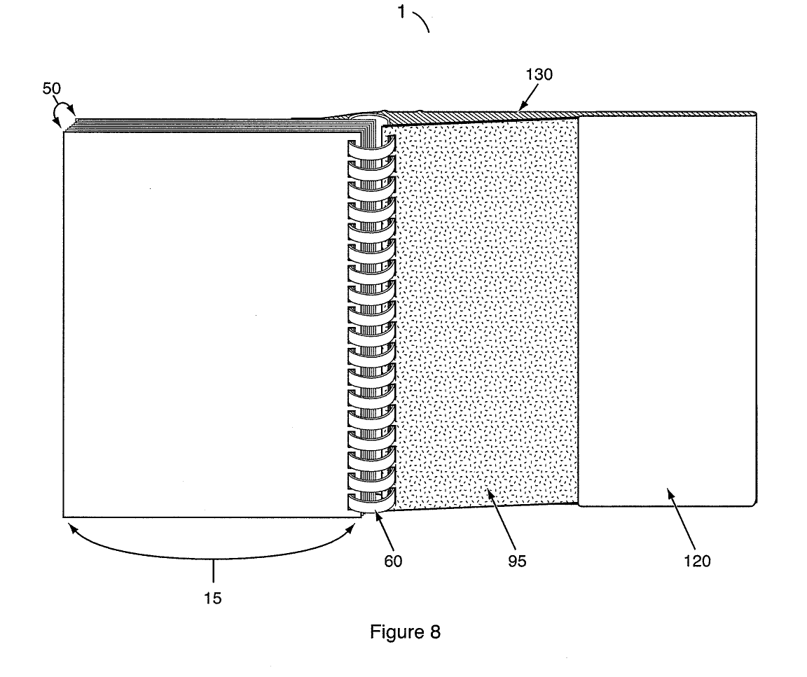

FIG. 8 is an illustration of the back interior of document binder assembly 1 in a completed state. Document binder assembly 1 is in a completed state when the bound document 5 is covered by cover 110, and slide 95 is attached to bound document 5 in a manner as to receive spacer 70 which is attached to cover 110. Slide 95 is connected to bound document 5 via binding member 60.

When document binder assembly 1 is in a completed state, spacer 70 is hidden in document binder assembly 1 by second wrap portion 120. Slide 95 is configured to slide between the second wrap portion 120 and intermediate portion 130. Preferably, the portion of slide 95 which defines the notch 80 for receiving spacer 70 is covered by second wrap portion 120 for aesthetic reasons. Additionally, second wrap portion 120 completely covering notch 80 and spacer 70 reduces the chance of slide 95 misaligning to such a position that slide 95 cannot receive spacer 70.

FIG. 9 is an illustration of an embodiment using a snap for a spacer. Document binder assembly 1 comprises binding member 60, which receives the multiplicity of pages 50 and slide 95. The insert portion of slide 95, which is the right side of slide 95 as illustrated in FIG. 9, defines notch 80 for receiving spacer 70. In this embodiment of the present invention, spacer 70 comprises a connected snap, which is formed by the connection of first snap half 71 and second snap half 72. This connected snap forms a bound area, which serves the purpose of spacer 70, and is received by slide 95 via notch 80 to accomplish the purposes of the present invention.

FIG. 9 illustrates a single snap as spacer 70. However, those skilled in the art will appreciate that any number of snaps may be used to accomplish the objectives of the present invention. Notch 80 will vary in size to receive the number of snaps used to comprise spacer 70.

FIGS. 10A, 10B & 10C illustrate an embodiment utilizing tabs and slots to comprise the spacer. FIG. 10A provides an interior view of document binder assembly 1 utilizing tabs and slots to comprise the spacer 70. Document binder assembly 1 comprises binding member 60, which receives the multiplicity of pages 50 and slide 95. The insert portion of slide 95, which is the right side of slide 95 as illustrated in FIG. 10A, defines notch 80. Intermediate portion 130 comprises slots 73, which may be of any length, but adequate to receive tabs 76 on first wrap portion 30.

FIG. 10B provides an interior view of the document binder assembly utilizing tabs and slots to perform the function of the spacer once the slide has been inserted between the first wrap portion 30 and intermediate portion 130. The notch 80 defined by the insert portion of slide 95 is not visible, as notch 80 is hidden by first wrap portion 30, and receives the spacer 70, or bound area defined by the slots 73 receiving the tabs 76. Notch 80 may vary in size as to comfortably receive the bound area defined by the slots 73 receiving the tabs 76. This bound area serves the purpose of spacer 70, and thus, comprises spacer 70 in this embodiment of the invention.

FIG. 10C provides a rear view of the document binder assembly utilizing tabs and slots to perform the function of the spacer. The rear of bound document 5 comprising a multiplicity of pages 50 bound together by binding member 60 is covered by intermediate portion 130. Slots 73 in intermediate portion 130 receive tabs 76 to create a bound area, wherein said bound area comprises spacer 70. Once the slots 73 receive the tabs 76, the result is a bound area which comprises the spacer 70 for purposes of the present invention. In FIG. 10C, four slots 73 and four tabs 76 are shown. However, those skilled in the art will appreciate that the present invention in this particular embodiment may comprise any number of slots 73 and tabs 76, including only one slot 73 and tab 76.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

What is claimed is:

1. A document binder assembly comprising:
a slide having an insert portion at a first side thereof and an engagement portion at a second opposite side thereof;
a cover including a first wrap portion at a first side thereof, a second wrap portion at a second opposite side thereof, the second wrap portion receiving the insert portion of the slide, and an intermediate portion between the first wrap portion and the second wrap portion; and
a spacer affixed to said cover of the document binder assembly and received by the slide by a notch in the slide.

2. The document binder assembly of claim 1, wherein said intermediate portion comprises a spine portion.

3. The document binder assembly of claim 1, wherein said first wrap portion is secured to the first page of a bound document.

4. The document binder assembly of claim 3, wherein said first page of a bound document is the cover of the bound document.

5. The document binder assembly of claim 1, wherein said spacer is located between the second wrap portion and said intermediate portion.

6. The document binder assembly of claim 1, wherein said slide is adapted to slide between said second wrap portion and said intermediate portion relative to said spacer.

7. The document binder assembly of claim 1, wherein said spacer is adhesive.

8. The document binder assembly of claim 1, wherein said spacer is a snap.

9. The document binder assembly of claim 1, wherein said spacer comprises a Velcro (TM) fastener.

10. The document binder assembly of claim 1, wherein said spacer comprises an adhesive area.

11. The document binder assembly of claim 1, wherein said spacer is interlocking tabs.

12. The document binder assembly of claim 1, further comprising a second spacer.

13. The document binder assembly of claim 10, wherein said second spacer is attached to the cover and is received by the slide.

14. The document binder assembly of claim 1, wherein said cover comprises printed material.

15. A cover for a bound document comprising a multiplicity of sheets and having a binding member, said cover comprising:
a cover adapted to be affixed to a first page of a bound document;
a slide attachable to the binding member, and cooperative with said cover for linking said cover the said binding member; and
a wrap portion for holding the slide in position relative to the spacer.

16. The cover of claim 15, wherein said slide is configured to hold a portion of the cover at the back of the document.

17. The cover of claim 15, wherein said slide defines a notch therein for receiving said spacer.

18. The cover of claim 15, wherein said cover comprises a sheet of paper with dimensions of 11 inches by 17 inches.

19. The cover of claim 15, wherein said multiplicity of sheets comprises a multiplicity of A4 sheets of paper.

20. The cover of claim 15, wherein said spacer comprises an object comprising adhesive on both sides.

21. A method for manufacturing a document binder assembly comprising a cover for a bound document, said method comprising:
producing the cover for the bound document, said cover comprising a first wrap portion on a first side thereof, a second wrap portion at a second opposite side thereof, and an intermediate portion between the first wrap portion and the second wrap portion that includes a spine portion;
attaching a slide to the last page of the bound document, said slide comprising a notch; and
affixing a spacer to the cover of the document binder assembly, wherein said spacer is affixed in such a location as to enable the slide to receive the spacer via a notch.

22. The method for manufacturing a document binder assembly of claim 21, wherein attaching a slide to the last page of the bound document further comprises attaching the slide wherein said slide is located between the second wrap portion and said intermediate portion.

23. The method of manufacturing a document binder assembly of claim 21, wherein producing a cover for the bound document comprises producing a cover that may be received by a printer.

24. The method of claim 21 further comprising the step of applying adhesive to the spine portion.

25. The method of claim 21, wherein affixing a spacer to the cover of the document binder assembly comprises adhering the spacer via adhesive to the cover.

26. The method of claim 21, wherein affixing a spacer to the cover of the document binder assembly comprises adhering the spacer via a snap affixed to the cover.

27. The method of claim 21, wherein affixing a spacer to the cover of the document binder assembly comprises interlocking tabs located on the cover together as to form a bound area.

28. A method for creating a reinforced document binder assembly, said document binder assembly including a cover, a bound document and a spine portion, said method comprising the steps of:
creating a cover for a bound document with a cover, said cover comprising a spine portion; and,
applying adhesive to said spine portion of said cover.

29. The method of claim 28, wherein the step of applying adhesive to said spine portion of said cover comprises applying adhesive to the interior side of said spine portion.
